(19) United States
(12) Patent Application Publication
(10) Pub. No.: US 2008/0214713 A1
(43) Pub. Date: Sep. 4, 2008

(54) Antistatic Method For Biodegradable Polyester Resin Composition And Products Thereof

(76) Inventors: Tadashi Hasebe, Osaka (JP); Soichiro Kamiya, Osaka (JP); Kazuyuki Sashida, Kyoto (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/544,928

(22) PCT Filed: Feb. 4, 2004
(86) PCT No.: PCT/JP2004/001126

§ 371 Date: Jan. 10, 2008

(30) Foreign Application Priority Data
Feb. 10, 2003 (JP) 2003-031856

(51) Int. Cl. C08K 5/101

(52) U.S. Cl. 524/315

(57) ABSTRACT

The present invention relates to antistatic method for a polyester polymer or resin which is a biodegradable resin, especially polybutylene succinate, etc., having a high antistatic ability and persistence thereof, suppressing bleeding with a slight environmental load and to provide a film, a sheet and a molded product, moreover, to provide the antistatic method for the biodegradable polyester resin composition comprising a diglycerol fatty acid ester in a polyester resin having biodegradability, said polyester resin composition is at least one of polybutylene succinate, polyethylene succinate, polybutylene adipate, or polybutylene succinate adipate, constituent fatty acids of said diglycerol fatty acid ester have 16-18 Carbon atoms, and HLB of the diglycerol fatty acid ester is within the range of 4-8, moreover, the content of the diglycerol fatty acid is =0.2 to <2.0 wt. %.

### TECHNICAL FIELD

The present invention relates to an antistatic method for a biodegradable polyester resin composition, and products made of said composition, such as films, sheets and other molded articles. In detail, the invention relates to an antistatic method for a biodegradable polyester resin composition, and products made of said composition, such as films, sheets, and other molded articles, which are featured in being provided with antistatic performance with respect to a biodegradable polyester resin.

### BACKGROUND ARTS

Products made of synthetic resins such as polyethylene, polystyrene, polypropylene or polyvinyl chloride, hereinafter called as plastic products, are utilized in various fields in foodstuff packaging, building materials, and/or electric household appliances, and are indispensable in daily lives. However, in cases where the plastic products become waste after use since the plastic products have a feature of durability, degradability in nature is inferior to other materials, wherein the plastic products have a negative aspect which is a cause of environmental damage in that the remaining plastic products adversely influence the ecosystem of the living things.

Biodegradable plastics are spotlighted in order to conquer such shortcomings of plastics. The biodegradable plastics display performance similar to that of conventional plastic during use. However, after use, the biodegradable plastics are decomposed to low molecular compounds in a short period of time by virtue of actions of enzymes produced by microbes or microorganisms living in the environment, and finally is decomposed to water and carbon dioxide.

In line with the recent surge in consciousness with respect to environmental problems, recycling of plastic products are legally regulated, wherein so-called biodegradable plastics which are decomposed in the environment have been spotlighted along with recycling and re-use of plastic products, and government and private companies have been actively engaged in research and study of biodegradable plastics. The assumed applications or uses of the biodegradable plastics are as agricultural materials particularly used in the environment (for example, sheets and films used for house cultivation of root vegetables) and materials (for example, foodstuff packaging films, sheets or plates) used in the foodstuff packaging field, which are difficult to be collected after use.

Biodegradable plastics are roughly divided into a microbe production system, a natural product utilization system, and chemical synthesization system. However, biodegradable plastics that are made into practical use at present are fatty acid polyester series, denatured polyvinyl alcohol, starch-denatured things, and those blends broadly classified.

Polybutylene succinate and polyhydroxybutylate, etc., are available as the fatty acid polyester. Of these, polybutylene succinate and polybutylene succinate adipate are soft resins showing a modulus of elasticity equivalent to that of polyethylene. Therefore, it can be expected that these resins are applied in wide and various fields such as films, sheets, etc.

However, generally, macromolecular compounds are liable to be electrified by friction, etc., wherein dust and foreign substances are adhered thereto, thereby spoiling the appearance thereof. For this reason, it is necessary to provide the compounds with antistatic performance.

In order to provide a macromolecular compound with antistatic performance, a method for using antistatic agents has been well known. There are two types of antistatic agents, one of which is a coating type and the other of which is a kneading type. Examples of a coating type of antistatic agents of a resin, in which biodegradable polyester is used as its main constituent, include one (for example, refer to Patent Document 1) composed of saccharose lauric acid ester and a water-soluble polymer, fluorine-based compound (for example, refer to Patent Document 2) having a perfluoroalkyl group and a perfluoroalkenyl group in molecules, a specified anion-based surfactant and a specified non-ion surfactant (for example, refer to Patent Document 3). However, in the case of the coating type, a problem arises in that the sustainability or durability is deterioleated, films become sticky, and blocking between films occurs easily.

As the kneading type antistatic agents, followings may be listed general surfactants, anion-based surfactants such as, for example, an fatty acid amine system, and alkyl sulfate system, etc., cation-based surfactants such as quaternary ammonium salt, etc., non-ion based surfactants such as sorbitan fatty acid ester, glycerin fatty acid ester, etc., and amphoteric surfactants such as alkylbetaine base (for example, refer to Non-Patent Document 1).

In particular, anion-based surfactants such as alkylsulfate metal, alkylbenzenesulfonate metal, etc., are effective as an antistatic agent of aromatic polyester resin such as polyethylene terephthalate (for example, refer to Patent Documents 4 and 5). However, adverse influences are serious in that biodegradable fatty acid polyester resins are colored with anion-based surfactants, cation-based surfactants, and amphoteric surfactants, and the physical properties of molded articles are spoiled.

As glycerin fatty acid ester, which is generally used for non-ion surfactants, polyorefin, etc have been widely used. An effect has been confirmed with respect to a biodegradable polyester such as polylactic acid. However, unless the glycerin fatty acid ester is blended with resin by 3.5 through 7.5 parts, no antistatic effect can be brought about. Also, since the blending amount is large, the physical properties of a molded article may deterioleate, and further the sustainability of the antistatic performance is not sufficient (for example, refer to Patent Document 6).

Although polyalcohol fatty acid esters such as ethylene glycol, diethylene glycol, trimethylol propane, sorbitol, etc., are effective for polylactic acid (for example, refer to Patent Documents 7 and 8), the esters are less effective for biodegradable fatty acid polyesters such as polybutylene succinate, etc.

[Non-Patent Document 1] “Newest technology of antistatic agents, and development of applications” CMC Co., Ltd., Apr. 15, 1996, Pages 69 through 77.

[Patent Document 1] Japanese Unexamined Patent Publication No. 2000-280410 (Pages 1 through 5)
[Patent Document 2] Japanese Unexamined Patent Publication No. H10-86307 (Pages 1 through 13)
[Patent Document 3] Japanese Unexamined Patent Publication No. 2002-12687 (Pages 1 through 5)
[Patent Document 4] Japanese Unexamined Patent Publication No. H05-222357 (Pages 1 through 7)
[Patent Document 5] Japanese Unexamined Patent Publication No. 2002-155152 (Pages 1 through 13)
[Patent Document 6] Japanese Unexamined Patent Publication No. H10-36650 (Pages 1 through 14)
[Patent Document 7] Japanese Unexamined Patent Publication No. H09-221587 (Pages 1 through 8)
[Patent Document 8] Japanese Unexamined Patent Publication No. 2002-114900 (Pages 1 through 6)

### DISCLOSURE OF INVENTION

### Objects to be Solved by the Invention

It is an object of the present invention to provide an antistatic method with respect to polyester-based polymers or resins which are biodegradable resins, in particular polybutylene succinate, that is, an antistatic method for biodegradable polyester resin compositions having high antistatic performance and its sustainability, which can suppress generation of bleeding and has high safety and sufficiently reduces environmental load, and to provide films, sheets and other molded articles.

### Means for Solving the Object

In order to achieve the objects, the present invention includes the following composition.

(1) an antistatic method for biodegradable polyester resin compounds in which diglycerol fatty acid ester is contained in a polyester resin having biodegrability, wherein composition fatty acid of the above-described diglycerol fatty acid ester is 16 through 18 in terms of carbon number, HLB of the above-described diglycerol fatty acid ester is 4 through 8, and the content of the above-described diglycerol fatty acid is above 0.2 wt % (weight percent) to less than 2.0 wt %.

(2) The antistatic method for biodegradable polyester resin compounds as set forth in the above (1), wherein the polyester resin is polybutylene succinate, polyethylene succinate, polybutylene adipate, or polybutylene succinate adipate.

(3) Films, sheets or other molded articles having antistatic performance being featured in that the above-described films, sheets or other molded articles are molded by using the biodegradable polyester resin compounds as set forth in the above (1) or (2).

### EFFECT OF THE INVENTION

According to the present invention, it becomes possible to provide biodegradable polyester resin products that have high antistatic performance and sustainability thereof, can suppress generation of bleeding, and are friendly to the environment without damaging the physical properties such as mechanical strength, etc.

### BEST MODE FOR CARRYING OUT THE INVENTION

A further detailed description is given of the invention.

Biodegrabale polyester in the present invention mainly covers polybutylene succinate, polyethylene succinate, polybutylene adipate or polybutylene succinate adipate. With respect to biodegradable polyester resins used, the degree of polymerization and quality thereof do not matter. Copolymers such as glycol acid, ε-caprolactone, trimethylene carbonate or polyethylene glycol, etc., may be concurrently used. Also, as long as the physical properties of biodegradable polyester resin are not spoiled, cellulose acetate, polycaprolactone, copolymer of polyhydroxy butylate and varilate, chitin, chitosan or other biodegradable macromolecules such as starch, etc., may be blended.

Diglycerin fatty acid ester used for the present invention is obtained by an esterizing reaction of diglycerol and fatty acid. However, the production method thereof is not especially limited. Also, it is preferable that the esterization ratio of diglycerin fatty acid ester used for the invention is 4 through 8 in terms of HLB (Hydrophile-Lipophile Balance), wherein it is particularly preferable that diglycerin mono fatty acid ester and diglycerin di fatty acid ester are used as major constituents. In a case where the HLB is lower than 4, bleeding is frequently generated, which adversely influences the appearance of a molded article. In a case where the HLB is higher than 8, it takes a significant amount of time to generate antistatic effects. In addition, where the glycerin chain length is lengthened like triglycerin fatty acid ester, etc., it is not preferable in that the antistatic effects deterioleates.

It is preferable that the composition fatty acid of diglycerin fatty acid ester used in the present invention is 16 through 18 in terms of carbon number. In a case where the carbon number is smaller than 16, it takes a significant amount of time until the effect is brought about after the diglycerin fatty acid ester is kneaded in a resin. In a case where the carbon number is larger than 18, bleeding is frequently generated, and a molded article becomes sticky.

In the present invention, the content of diglycerin monofatty acid ester with respect to resin is above 0.2 wt % to less than 2.0 wt % with respect to the resin, and preferably a range of above 0.4 wt % to under 1 wt % is desirable in terms of securing antistatic performance and sustainability thereof, and suppressing the generation of bleeding, which are the objects of the invention. If the content is lower than the range, the performance is not sufficient, and if the content exceeds the range, the physical properties may be spoiled, and bleeding of the antistatic agent is frequently generated.

A polyester resin composition according to the invention may be thermally molded by extrusion and injection using an extruder and an injection molding machine which are used in general plastic molding. It is preferable that the molding temperature is 160 through 220° C. Where polymer blending is carried out, a two-axis extruder is further preferable. A resin composition melted in an extruder is molded to a sheet or film by T-die, inflation, etc. The film may be molded through either extension or non-extension. Also, a molded article such as a plate may be obtained by using an injection molding machine.

In addition, a plasticizer, stabilizer, antioxidant, lubricate, slipping agent, and antifogging agent, etc., may be concurrently used. However, the additives may be used as long as the additive agents do not hinder the antistatic performance of the invention.

### EMBODIMENT

A detailed description is given of the present invention with reference to embodiments. The invention is not limited to the embodiments.

### Embodiments 1 Through 4, Comparative Examples 1 Through 8

In the embodiments, “BIONOLLE” (Grade #1001, Polybutylene Succinate), which is produced by Showa Highpolymer Co., Ltd., is used as a biodegradable fatty acid polyester resin. In order to prevent the molecular weight from being lowered due to hydrolysis, after the resin was subjected to drying through heating at 80° C. for 6 hours and humidity was removed, prescribed amounts (described in Table 1) of the following test samples were blended with respect to the resin for each of the embodiments and comparative examples, and extruded pellets were produced at 200° C. by using a two-axis extruder. By using these pellets, test samples described in respective tests were produced by extrusion molding, wherein the surface specific resistance, half-value period and bleeding property were confirmed.

### [Test-1] Surface Specific Resistance

A test piece which is a molded article of 100×100 mm and 2 mm thickness was used. The test piece that was aged at the room temperature of 20° C. and humidity 65% RH for one week was measured under the same conditions in terms of the surface specific resistance by an ultra-sensitive insulation resistance tester SEM-10 type (Products of DKK-TOA Corporation). The application voltage was 500V, and the surface specific resistance was read in one minute.

### [Test-2] Half-Value Period of Electric Charge

A test piece which is a molded article of 45×40 mm and 2 mm thickness was aged at a room temperature of 20° C. and humidity of 65% RH for one week. The test piece was measured by using a static honestmeter S-5109 type (Products of Shishido Electrostatic Co.). The application voltage was 9 kV, application time was 10 seconds, discharge height was 1.5 cm, power receiving height was 1.0 cm, and the number of revolutions of the disk was 1000 r.p.m.

### [Test-3] Bleeding Property Test

Those in which no bleeding is recognized are marked with symbol “∘”, and those in which bleeding is recognized are marked with symbol “x”.

### [Test Sample-1]

Diglycerolstearate (“RIKEMAL” S-71-D: Products of RIKEN VITAMIN Co. HLB 5.7)

### [Test Sample-2]

Diglycerolstearate (“RIKEMAL” DS-100A: Products of RIKEN VITAMIN Co. HLB 7.7)

### [Test Sample-3]

Diglycerolol oleate (“RIKEMAL” DXO-100: Products of RIKEN VITAMIN Co. HLB 7.0)

### [Test Sample-4]

Diglycerol laurate (“RIKEMAL” L-71-D: Products of RIKEN VITAMIN Co. HLB 7.3)

### [Test Sample-5]

Diglycerolbehenate (HLB 6.0)

Diglycerolbehenate whose HLB is approximately 6.0 was obtained by an esterizing reaction using 1 mol of diglycerol and 1 mol of behenic acid.

[Test sample-6]

Diglycerolstearate (HLB 2.4)

Diglycerolstearate whose HLB is approximately 2.4 was obtained by an esterizing reaction using 1 mol of diglycerol and 3 mols of stearic acid.

### [Test Sample-7]

Diglycerolstearate (HLB 10.8)

Diglycerolstearate whose HLB is approximately 10.8 was obtained by an esterizing reaction using 1 mol of diglycerol and 0.5 mol of stearic acid.

### [Test Sample-8] Products of

Glycerolstearate (“RIKEMAL” S-100: Products of RIKEN VITAMIN Co. HLB 4.3)

### [Test Sample-9]

Triglycerolstearate (HLB 8.9)

Triglycerolstearate whose HLB is approximately 8.9 was obtained by an esterizing reaction using 1 mol of triglycerol and 1 mol of stearic acid.

### [Test Sample-10]

Alkylsulfonate (ANSTEX HT-100: Products of Toho Chemical Industry Co., Ltd.)

### HLB Calculation Expression

20×(1−S/A)

S: Saponification number

A: Neutralization number (Acid number) of composition fatty acid

Results of tests and evaluation are shown in Table 1

TABLE 1

| | | Surface | Half- | |
|---|---|---|---|---|
| | Additive amount | specific | value | |
| | of test sample | resistance | period | |
| | (% by weight) | (Ω) | (sec) | Bleeding |
| Embodiment 1 | Test sample-1 | 3 × 10¹⁰ | 5 | ∘ |
| | 0.5% by weight | | | |
| Embodiment 2 | Test sample-1 | 2 × 10⁹ | 4 | ∘ |
| | 1.9% by weight | | | |
| Embodiment 3 | Test sample-2 | 2 × 10¹⁰ | 6 | ∘ |
| | 1% by weight | | | |
| Embodiment 4 | Test sample-3 | 4 × 10⁹ | 3 | ∘ |
| | 1.9% by weight | | | |
| Comparative | Test sample-1 | 5 × 10¹⁴ | 120↑ | ∘ |
| example 1 | 0.1% by weight | | | |
| Comparative | Test sample-4 | 4 × 10¹⁴ | 108 | ∘ |
| example 2 | 1% by weight | | | |
| Comparative | Test sample-5 | 5 × 10¹¹ | 15 | x |
| example 3 | 0.5% by weight | | | |
| Comparative | Test sample-6 | 3 × 10¹¹ | 12 | x |
| example 4 | 0.5% by weight | | | |
| Comparative | Test sample-7 | 9 × 10⁴ | 120↑ | ∘ |
| example 5 | 1% by weight | | | |
| Comparative | Test sample-8 | 4 × 10¹⁵ | 120↑ | ∘ |
| example 6 | 1% by weight | | | |
| Comparative | Test sample-9 | 10¹⁶↑ | 120↑ | ∘ |
| example 7 | 1% by weight | | | |
| Comparative | Test sample-10 | 2 × 10¹⁴ | 97 | ∘ |
| example 8 | 1% by weight | | | |

Also, in Table 1 above, [120↑] means that the values exceeds 120.

### Embodiment 5

Embodiment 5 differs from Embodiment 1 only in that, in the test sample-1 of the embodiment 1, the additive amount of the test sample was changed from 1.9 wt % to 5.0 wt %, while all other conditions remain unchanged. A test piece which is 10 cm long and 10 mm wide was measured in terms of its tensile strength (Mpa) in compliance with the measurement method of ASTM-D882. With respect to the pieces in which the additive amount is 1.9 wt %, the tensile strength equivalent to the test sample 1 of Embodiment 1 could be obtained. However, with respect to those in which the additive amount is 5.0 w %, the tensile strength deterioleated by 20%.

1. An antistatic method for biodegradable polyester resin compounds in which diglycerol fatty acid ester is contained in a polyester resin having biodegrability, wherein composition fatty acid of the above-described diglycerol fatty acid ester is 16 through 18 in terms of carbon number, HLB of the above-described diglycerol fatty acid ester is 4 through 8, and the content of the above-described diglycerol fatty acid is 0.2 or more % by weight to 2.0 or less % by weight.

2. The antistatic method for biodegradable polyester resin compounds as set forth in claim 1, wherein the polyester resin is polybutylene succinate, polyethylene succinate, polybutylene adipate, or polybutylene succinate adipate.

3. A film, sheet or molded article having antistatic performance being featured in that the above-described film, sheet or molded article is molded by using the biodegradable polyester resin compound as set forth in claims 1 or 2.
